(19) United States
(12) Patent Application Publication
(10) Pub. No.: US 2006/0038862 A1
(43) Pub. Date: Feb. 23, 2006

(54) Inkjet printer

(76) Inventor: Ryuji Tanno, Tokyo (JP)

Correspondence Address: CANTOR COLBURN, LLP, 55 GRIFFIN ROAD SOUTH, BLOOMFIELD, CT, 06002, US

(21) Appl. No.: 11/203,930

(22) Filed: Aug. 15, 2005

(30) Foreign Application Priority Data
Aug. 23, 2004 (JP) JP2004-242421

(51) Int. Cl. B41J 2/17; B41J 2/175

(52) U.S. Cl. 347/84; 347/85

(57) ABSTRACT

An inkjet printer includes an ink-supply tube, a damper for temporarily storing ink at a midway of the ink-supply tube, an ink-feed pump, an ink detection section for detecting whether an ink amount in the damper is not smaller than a predetermined amount, and a control section for controlling the ink-feed pump, according to a detection result. The damper includes an ink chamber for storing ink, a damper membrane that expands and shrinks, corresponding to an ink amount in the ink chamber, and a regulating member for regulating an expansion amount of the damper membrane, the member disposed outside the damper membrane. The ink detection section includes a moving section that moves according to a displacement of the damper membrane and a detection sensor for detecting whether the ink amount in the damper is not smaller than the predetermined amount, based on a travel distance of the moving section.

### FIELD OF THE INVENTION

The present invention relates to an inkjet printer, and particularly relates to an inkjet printer for image recording using ink with high viscosity.

### BACKGROUND OF THE INVENTION

In general, as means for performing printing on various recording media, inkjet printers are known. An inkjet printer uses, for example, a piezo device or a heater to jet ink from recording heads onto a recording medium such as paper, as tiny droplets, and moves the recording heads on the recording medium while penetrating the ink into or fixing the ink on the recording medium, thereby performing image recording on the recording medium. Accordingly, the inkjet printer does not require a plate making process and thus has an advantage to achieve printing to meet the demands. Particularly, in recent years, inkjet printers are known which use photo-curable ink that is cured by light, such as UV light, and irradiate light onto ink having reached a recording medium to cure the ink on a recording medium. Thus, it is possible to easily perform printing on a non-ink-absorbent recording medium, such as a transparent or lucent resin film.

Such an inkjet printer is provided with ink supply tubes to supply ink from ink tanks storing ink to recording heads. However, an ink flow in an ink supply tube causes a pressure drop, resulting in making it difficult to stably supply ink to a recording head. To solve this problem, in recent years, an inkjet printer has been developed, wherein a sub-tank is provided at the midway of an ink supply tube such that the sub-tank (damper) for temporarily storing ink is disposed near the recording head, thereby allowing stable ink supply with inhibited pressure drop (refer to Patent Document 1).

Further, in this type of inkjet printer, image recording is generally performed while supplying ink as needed, from the tank for storing the ink to the recording head, but the quantity of ink that is stored in the ink tank decreases as image recording operations are repeated. Thus, in order to perform the image recording operation smoothly and continuously, it is necessary to accurately determine the quantity of ink remaining in the ink tank, and to properly replenish ink when there is no remaining ink.

As a result, a method was carried out in which a weight sensor provided in the ink tank, detects the quantity of remaining ink by determining the change in weight of the ink tank. Alternatively a method was performed in which the quantity of ink remaining in the ink tank was calculated by keeping count of the quantity of ink which is jetted during image recording, and subtracting the counted ink quantity from the total ink quantity in the ink tank (for example Patent Document 2).
[Patent Document 1] Patent No. 2934016
[Patent Document 2] TOKKAIHEI No. 9-248917

However, the ink tank has various parts such an outer ink casing, joint members and the like. Consequently, in the method providing a weight sensor in the ink tank, when an attempt is made to detect the weight of the ink inside the ink tank, the weight of these parts is also measured along with the weight of the ink in the tank, and this caused a problem in that weight measurement could not be performed with high accuracy. Further, there were also sometimes jetting abnormalities due to missing nozzles and the like, or ink would be forcibly absorbed from the nozzle at the time of cleaning the recording head, or sometimes there would be ink outflow as a result of air jetting. However, the method of counting the quantity of ink ejected during image recording does not count this type of ink outflow, and in addition, because high accuracy management of the ink outflow due to jetting abnormalities and ink outflow at the time of cleaning is difficult, there was a problem in that the quantity of ink remaining could not be accurately determined.

### SUMMARY OF THE INVENTION

To solve problems as described above, an embodiment of the invention is to provide an inkjet printer that properly detects the amount of remaining ink in a damper provided in the midway of an ink supply tube to temporarily store ink, accurately and easily detects a time when the amount of remaining ink is short and a time for replenishing ink, and it is always possible to perform constant ink amount detection without adjusting the disposition of an ink detector for detecting the amount of remaining ink, thereby securing stable ink jetting.

In an aspect of the invention, an inkjet printer includes an ink-tank for storing ink, a recording head for jetting ink onto a recording medium, an ink-supply tube for supplying ink from the ink-tank to the recording head, a damper for temporarily storing ink at a midway of the ink-supply tube, an ink-feed pump for feeding ink to the damper, the pump disposed between the ink-tank and the damper, an ink detection section for detecting whether an ink amount in the damper is greater than or equal to a predetermined amount, a control section for performing control to stop the ink-feed pump if a detection result by the ink detection section is greater than or equal to the predetermined amount, and drive the ink-feed pump if the detection result is smaller than the predetermined amount. Herein, the damper includes an ink chamber for storing ink supplied from the ink supply tube; a damper membrane that covers at least one surface of the ink chamber and expands and shrinks, corresponding to an ink amount in the ink chamber; and a regulating member for regulating an expansion amount of the damper membrane to regulate an ink amount in the ink chamber, the member disposed outside the damper membrane and on the inner side than a maximum expansion position of the damper membrane. The ink detection section includes a moving section that moves according to a displacement of the damper membrane while having contact with an outer surface of the damper membrane, and a detection sensor for detecting whether the ink amount in the damper is greater than or equal to the predetermined amount, based on a travel distance of the moving section.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic side view of a main part of an inkjet printer in a first embodiment according to the invention;

FIG. 2 is a side cross-sectional view of a damper provided in the inkjet printer;

FIG. 3 is a front view of the damper in FIG. 2; and

FIG. 4 is a block diagram showing a main part of a control structure of the inkjet printer in the first embodiment of the invention.

### DETAIL DESCRIPTION OF THE PREFERRED EMBODIMENTS

To attain an embodiment as described above, the invention includes the following structures.

Item 1 An inkjet printer includes an ink-tank for storing ink, a recording head for jetting ink onto a recording medium, an ink-supply tube for supplying ink from the ink-tank to the recording head, a damper for temporarily storing ink at a midway of the ink-supply tube, an ink-feed pump for feeding ink to the damper, the pump disposed between the ink-tank and the damper, an ink detection section for detecting whether an ink amount in the damper is greater than or equal to a predetermined amount, a control section for performing control to stop the ink-feed pump if a detection result by the ink detection section is greater than or equal to the predetermined amount, and drive the ink-feed pump if the detection result is smaller than the predetermined amount. Herein, the damper includes an ink chamber for storing ink supplied from the ink supply tube; a damper membrane that covers at least one surface of the ink chamber and expands and shrinks, corresponding to an ink amount in the ink chamber; and a regulating member for regulating an expansion amount of the damper membrane, the member disposed outside the damper membrane and inner than a maximum expansion position of the damper membrane. The ink detection section includes a moving section that moves corresponding to a displacement of the damper membrane while having contact with an outer surface of the damper membrane, and a detection sensor for detecting whether the ink amount in the damper is greater than or equal to the predetermined amount, based on a travel distance of the moving section.

According to Item 1, as the regulating member is disposed outside the damper membrane and inner than the maximum expansion position of the damper membrane and regulates the expansion amount of the damper membrane, the expansion amount can be made uniform by the regulation by the regulating member, even if there is variation in the maximum expansion amount (displacement amount) of the damper membrane caused by manufacturing process of the damper, a change with elapsed time with repeated expanding and shrinking of the damper, etc. If the expansion amount of the damper membrane is uniform, it is possible to make the travel distance of the moving section uniform even without adjusting the setting position of the ink detection section, and the ink amount can be detected always on the basis of the predetermined amount.

In this way, even if there is variation in the maximum expansion amount of the damper membrane, the detected ink amount is made uniform, which makes it unnecessary to adjust the setting position of the ink detection section, so that it is always possible to perform constant ink amount detection. Thus, the stability of ink jetting is secured.

Item 2 In the inkjet printer of item 1, the detection sensor determines that the ink amount in the damper is smaller than the predetermined amount if the moving section is inner than a regulated position by the regulating member of the damper for a predetermined distance, and the predetermined distance is longer than or equal to 0.5 mm and shorter than or equal to 4 mm.

According to Item 2, the position of the moving section at which the ink amount in the damper is determined to be smaller than the predetermined amount is inner than the regulated position by the regulating member for the predetermined distance which is longer than or equal to 0.5 mm and shorter than or equal to 4 mm, allowing it to maintain inside the ink chamber at the time of ink supply to be at a pressure in a range from −3 cm H₂O to −13 cm H₂O. If this pressure condition is maintained, ink can be stably supplied to the recording head.

Item 3 In the inkjet printer of Item 1 or 2, the damper is provided with an elastic member that is in contact with the damper membrane from inside the ink chamber and supports the damper membrane at an initial position.

According to Item 3, as the damper membrane is supported at the initial position by the elastic member, when ink is decreasing in the ink chamber, the elastic member pushes back the damper membrane shrinking inside the ink chamber so that a constant negative pressure condition is maintained in the damper. Accordingly, ink can be stably jetted from the recording head regardless of inflow or outflow of ink, and ink leakage from the recording head can be prevented at times other than image forming.

Item 4 In the inkjet printer of any one of items 1 to 3, the recording head heats ink, the ink being a liquid with a viscosity in a range from 10 to 500 mPa·s at 30° C., up to a range from 30° C. to 150° C. by a heater so as to jet the ink with a droplet size in a range from 2 to 20 pl per dot.

According to Item 4, image recording is performed using an ink with a high viscosity in a range from 10 to 500 mPa·s at 30° C.

Item 5 The inkjet printer of any one of Items 1 to 4 includes a light emitter for irradiating light onto ink having reached the recording medium, wherein the ink is a photo-curable ink curable by irradiating light and the light emitter is disposed on a downstream side of the recording head in a direction the recording medium is conveyed.

According to Item 5, ink jetted from the recording head is cured by irradiating light so that the ink is fixed on a recording medium.

Item 6 In the inkjet printer of Item 5, the ink is a UV-curable ink curable by irradiating UV light, and at least a part of light emitted by the light emitter is UV light.

According to Item 6, ink jetted form the recording head is cured by irradiating UV light so that the ink is fixed on a recording medium.

Item 7 In the inkjet printer of any one of Items 1 to 6, the ink is an ink that has a high viscosity and is a cation polymerization UV curable ink.

According to Item 7, image recording is performed using a monomer-based cation polymerization UV curable ink.

In accordance with the invention, even if there is variation in maximum expansion amounts (displacement amount) of damper membranes, the expansion amounts can be regulated by regulating members to be made uniform. If the expansion amounts of the damper membranes are uniform, the travel distances of moving sections can also be made uniform even without adjusting the setting positions of ink detection sections, allowing it to detect ink amounts always based on a predetermined amount.

Even if there is variation in the maximum expansion amounts of damper membranes, it is not necessary to adjust the setting positions of ink detection sections by making detected ink amounts uniform in this way, thereby allowing it to always perform constant ink amount detection. Therefore, stability of ink jetting is secured.

A first embodiment of the invention in accordance with the invention will be described, referring to the attached drawings.

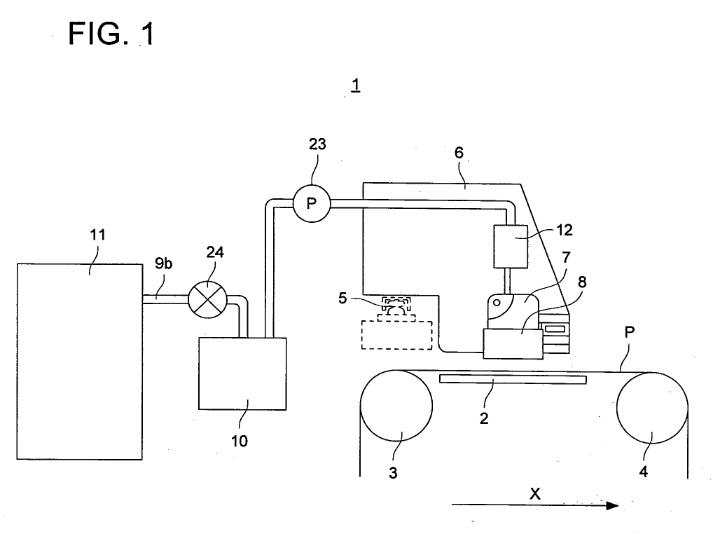

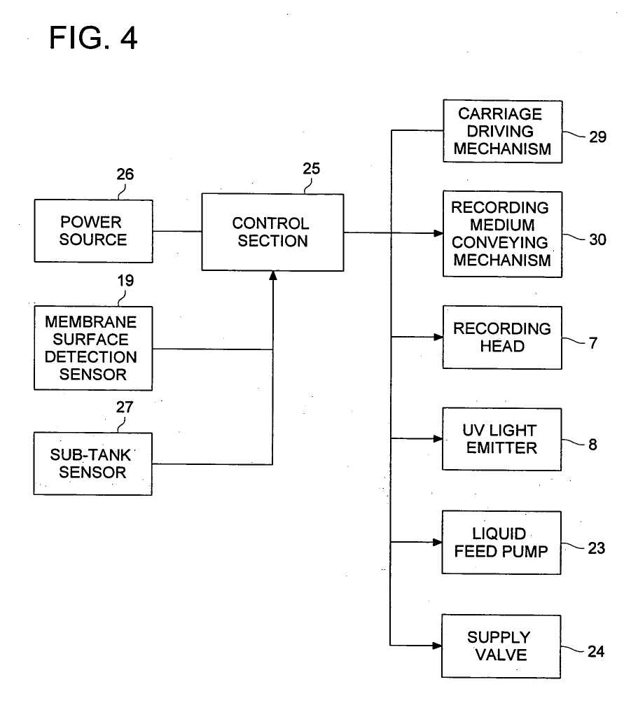

As shown in FIG. 1, an inkjet printer 1 in the present embodiment is a serial type inkjet printer which is provided with a platen 2 for supporting a flat-plate formed recording medium P at the non-recording side. Conveying rollers 3 and 4 which convey the recording medium P while maintaining it at approximately the same height as the platen 2 are rotatably provided on the upstream side and the downstream side of the platen 2. Herein, the conveying rollers 3 and 4 are rotated by a recording medium conveying mechanism 30 (see FIG. 4) so as to convey the recording medium P along the top surface of the platen 2 in a predetermined conveying direction X.

Above the platen 2, there is provided a guide rail 5 in a bar-form extending in the main scanning direction orthogonal to the conveying direction X in which the recording medium P is conveyed. This guide rail 5 supports a carriage 6 which is reciprocally moved by a carriage driving mechanism 29 (see FIG. 4) in the main scanning direction along the guide rail 5.

The carriage 6 has recording heads 7 mounted thereon which correspond to respective colors (for example, yellow (Y), magenta (M), cyan (C), and black (K)) used in the inkjet printer 1. A plurality of nozzles (not shown) for jetting ink is provided at the respective surfaces, facing the recording medium P, of the recording heads 7. The nozzles of the respective recording heads 7 are provided with a piezoelectric element (not shown) which deforms by applying a voltage. Herein, a driving voltage is applied to the piezoelectric element so that the piezoelectric element is deformed, thereby compressing the ink flow path to jet ink from the nozzles. Further, a heater (not shown) is arranged in the ink path to heat ink before jetting it. In order to achieve image recording with high resolution, ink is preferably jetted in a form of tiny droplets with a size of 2 to 20 pl per dot. Still further, ink used by the inkjet printer 1 is not limited to those shown as examples, and colors such as light yellow (LY), light magenta (LM), light cyan (LC), for example, can also be used. In this situation, recording heads 7 corresponding to the respective colors are mounted on the carriage 6.

Inks used in the present embodiment are photo-curable inks having a characteristic of being cured by irradiating UV ray as light and containing at least a polymerization compound (including known polymerization compounds), a photo-initiator, and a color material, as major components. Photo-curable inks can be broadly categorized into radical polymerization inks containing a radical polymerization compound, and cation polymerization inks containing a cation polymerization compound, as a polymerization compound, wherein both kinds of inks can be applied as ink used in the present embodiment. Further, hybrid type inks which are a mixture of a radical polymerization ink and a cation polymerization ink are also applicable as inks used in the present embodiment. However, cation polymerization compounds with which polymerization reaction is inhibited less by oxygen are advantageous in functionality and versatility. Accordingly, it is particularly preferable to use cation polymerization inks. Cation polymerization inks are a mixture containing at least a cation polymerization compound such as an oxetane compound, epoxy compound, vinyl ether compound, photo-cation initiator, and a color material.

Inks used in the present embodiment have a high viscosity in a range from 10 to 500 mPa·s at 30° C. The viscosity of an ink is decreased by heating the ink. In order to perform image recording with high resolution by having ink accurately reach a recording medium even in a case of smoothly jetting a highly viscous ink as tiny droplets, the ink is preferably heated to a temperature in a range from 30° C. to 150° C. by a heater before jetting.

Further, inside the carriage 6 and between each side wall of the carriage 6 and the recording heads 7, there is disposed a UV-light emitter 8 of the approximately same length as the length, in the recording medium conveying direction X, of the recording heads 7, wherein each UV-light emitters 8 is extending in the longitudinal direction of the recording heads 7. Each UV-light emitter 8 is provided with a UV-light source, not shown. As a UV-light source, for example, a high pressure mercury lamp, low pressure mercury lamp, metal halide lamp, semiconductor laser, cold-cathode tube, excimer lamp, or LED (Light Emitting Diode) can be applied. The positions for arranging UV-light emitters 8 are not limited to the above, wherein UV-light emitters may be provided between the respective recording heads.

The respective recording heads 7 are connected with sub-tanks 10 for temporarily storing inks in the respective colors of yellow (Y), magenta (M), cyan (C), and black (K) through respective ink supply tubes 9a formed of a flexible material. Further, the respective sub-tanks 10 are connected with main tanks (ink tanks) 11 through the respective ink supply tubes 9b, wherein inks in the main tanks 11 are supplied to the sub-tanks 10 by the ink supply tubes 9b, temporarily stored in the sub-tanks 10, and supplied to the respective recording heads 7. The positions of the sub-tanks 10 are set lower than the recording heads 7 so that inks in the recording heads 7 are maintained to be in a negative pressure condition, thereby preventing leakage of ink at times other than during image recording.

A sub-tank sensor 27 is provided in each sub-tank 10 to detect the amount of ink stored in the sub-tank 10. The sub-tank sensor 27 detects, for example, the liquid level of the ink stored in the sub-tank 10, wherein it can be recognized whether the amount of the ink in the sub-tank 10 is greater or equal to a predetermined amount, according to whether the liquid level of the ink is higher or equal to a predetermined level. Herein, the sub-tank 27 is not limited to the structure shown here as an example as long as the sub-tank sensor 27 can detect the amount of ink in the sub-tank 10, and can be a structure using a weight sensor, for example.

Further, at the midway of the ink supply tube 9a and between the sub-tank 10 and the recording head 7, a damper 12 for temporarily storing ink is provided adjacent to the recording head 7. By disposing the damper 12 adjacent to the recording head 7 in such a way, ink is supplied enough to the recording head 7 by supplying ink stored in the damper 12 in jetting ink, and thereby minimizing the effects by a pressure loss on ink jetting, caused thorough ink flowing inside the ink supply tubes 9a and 9b. Thus, ink jetting failure due to pressure loss can be prevented even in a case of using inks with high viscosity for image recording.

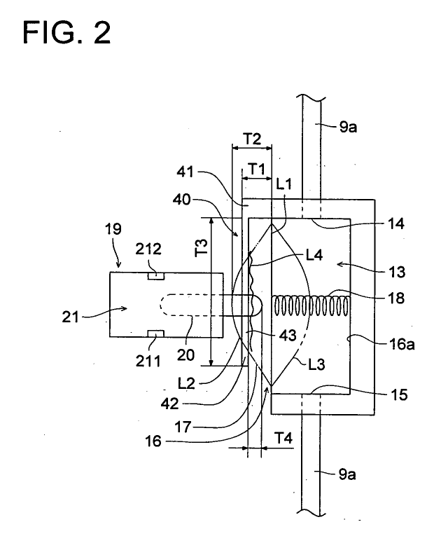

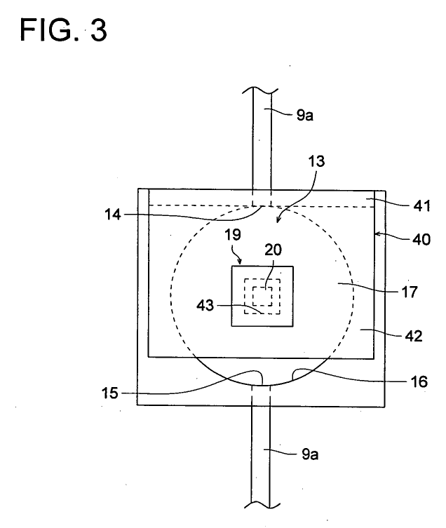

A dumper 12 will be described below in detail, referring to FIGS. 2 and 3. Herein, FIG. 2 is a side cross-sectional view of a damper 12, and FIG. 3 is a front view of the damper 12. As shown in FIGS. 2 and 3, the damper 12 is provided with an ink chamber 13 for storing ink supplied from the ink supply tube 9a. An ink inlet 14 for letting ink into the ink chamber 13 is provided at the top end of the damper 12, while an ink outlet 15 for letting ink out from the ink chamber 13 is provided at the bottom end of the damper 12. The ink inlet 14 and the ink outlet 15 are connected with respective ink supply tubes 9a, wherein ink fed from the sub-tank 10 flows into the ink chamber 13 through the ink supply tube 9a and from the ink inlet 14, and the ink having flowed into the ink chamber 13 is fed out from the ink outlet 15 and thorough the ink supply tube 9a to the recording head 7.

An opening 16 is formed through a side surface of the ink chamber 13, and a damper membrane 17 is stretched and arranged across the opening 16, covering the side surface of the ink chamber 13. The damper membrane 17 is made of a flexible film, such as a polyethylene film, and, for example, thermally welded to the opening 16 to seal the opening 16. Although the material of the flexible film structuring the damper membrane 17 is not limited to the one shown here as an example, some inks used for image recording have a corrosive nature. Therefore, a material having a corrosive proof is preferable at least for the part where ink directly contacts so that the damper membrane 17 is not deteriorated by ink stored in the ink chamber 13.

A coil spring 18 as an elastic member is provided inside the ink chamber 13 and on a wall surface 16a facing the opening 16, with its one end in contact with the damper membrane 17. The coil spring 18 supports the damper membrane 17 at a predetermined initial position (see the solid line part L1 in FIG. 2) when ink flows into the ink chamber 13 of the damper 12.

Herein, the initial position is a position where a certain negative pressure condition is maintained by the balance between the force of the ink, having flowed into the damper 12, to flow out to the recording head 7 with its gravity and the force of the coil spring 18 to hold the position of the membrane surface of the damper membrane 17. When ink flows into the ink chamber 13 of the damper 12, the damper membrane 17 deforms such that the damper membrane 17 is pressed by ink and expands outward (see the two dot chain line part L2 in FIG. 2). On the other hand, as ink in the ink chamber 13 decreases due to jetting ink from the recording head 7, the damper membrane 17 tends to deform, gradually shrinking inside (see the two dot chain line part L3 in FIG. 2). Herein, the coil spring 18 is pressed and shrunk by the damper membrane 17, thereby generating a reaction force to return to the original length. Then the damper membrane 17 is pushed back to the initial position by the reaction force of the coil spring 18, and gets balanced with the force of the damper membrane 17 to deform inside, thus inside the ink chamber 13 is in a negative pressure. In other words, even when the amount of ink in the ink chamber 13 decreases, although the damper membrane 17 temporarily shrinks inside, the damper 17 is then returned to the initial position by the coil spring 18. On the other hand, when the mount of ink increases, the damper membrane 17 expands outward. That is, the damper membrane 17 expands and shrinks, corresponding to the amount of ink in the ink chamber 13. Further, as described above, a negative pressure is maintained in the ink chamber 13 so that leakage of ink from the nozzles of the recording head 7 can be prevented at times other than during image recording.

Incidentally, although in the present embodiment, the coil spring 18 is used as an elastic member to support the damper membrane 17, the elastic member can be made of any material as long as the material is expandable and shrinkable to support the damper membrane 17, and not limited to the coil spring 18. Therefore, various springs including leaf springs or materials such as expandable and shrinkable resins can be used, for example.

Outside the damper membrane 17, a regulating member 40 is provided on the inner side of the maximum expansion position (see the two dot chain line part L2 in FIG. 2) of the damper membrane 17 to regulate the expansion amount of the damper membrane 17. This regulating member 40 includes a first extending part 41 extending outward from above the opening 16 and a second extending part 42 extending downward from the tip end of the first extending part 41. The horizontal length T1 of the first extending part 41 is set to be shorter than the horizontal length T2 from the vertex of the maximum expansion position of the damper membrane 17 to the base end of the first extending part 41. Further, the vertical length T3 of the second extending part 42 is disposed such that at least the tip end of the second extending part 42 is at a position lower than the center of the damper membrane 17. Thus, even when the damper membrane 17 tends to expand to the maximum expansion position, the expansion of the damper membrane 17 is regulated by the regulating member 40, as shown by the solid line L4 in FIG. 2. Herein, an opening 43 is provided through the second extending part 42 at a position facing the center of the damper membrane 17.

A membrane surface detection section 19 for detecting the position of the membrane surface of the damper membrane 17 is arranged outside the damper 12 and adjacent to the damper membrane 17, as an ink detection section for detecting whether the amount of ink in the ink chamber 13 is greater than or equal to a predetermined amount. A rod (moving section) 20 is provided at the membrane detection section 19 such that the tip end of the rod 20 is in contact with the outer surface of the damper membrane 17 through the opening 43 of the regulating member 40, wherein the rod 20 is formed in a length longer than the distance between the position where the damper membrane 17 is regulated by the regulating member 40 and the position where the damper membrane 17 shrinks to the most inner position. The rod 20 is movable, for example, by an actuator such as a cylinder, corresponding to the displacement of the damper membrane 17, and protrudes or moves back in response to the expanding and shrinking fluctuation of the damper membrane 17, wherein the tip end of the rod 20 is always in contact with the damper membrane 17. The membrane surface detection section 19 is provided with a detection sensor 21 which includes, for example, a light emitter 211 having a built-in light-emitting device that emits light such as infrared ray and a photo-detector 212 having a built-in photo-detecting device that detects light emitted from the light emitter 211. The light emitter 211 and the photo-detector 212 are respectively disposed with the light emitting face (not shown) of the light emitter 211 and the photo-detecting face (not shown) of the photo-detector 212 facing each other.

When ink flows into the damper 12, the damper membrane 17 is pressed outward and expands, and the rod 20 in contact with the damper membrane 17 is also pressed. In a state where the rod 20 is pressed deeper than the position, inside the membrane detection section 19, where the light emitter 211 and the photo-detector 212 are disposed, light emitted from the light emitter 211 is not detected by the photo-detector 212, shielded by the rod 20. On the other hand, when ink in the damper 12 decreases, the damper membrane 17 shrinks to the inner side of the damper 12, by which the rod 20 projects. In a state where the base end of the rod 20 projects before the point where the light emitter 211 and the photo-detector 212 are disposed, light emitted from the light emitter 211 is detected by the photo-detector 212. Thus, it is detected that the base end portion of the rod 20 is before a predetermined position, allowing it to determine whether the position of the damper membrane 17 in contact with the tip end of the rod 20 is in the inner side for a predetermined distance from the position where the position of the damper membrane 17 is regulated by the regulating member 40. If it is determined that the damper membrane 17 is outside the predetermined distance, the amount of ink in the damper 12 is greater than or equal to a predetermined amount, and if it is determined that the damper membrane 17 is inside the predetermined distance, the amount of the ink in the damper 12 is less than the predetermined amount. In such a manner, the membrane detection section 19 detects whether the amount of ink in the damper 12 is greater than or equal to the predetermined amount.

Herein, the predetermined distance is a position where the position of the damper membrane 17 is regulated by the regulating member 40, that is, the distance T4 of the regulating member 40 from the inner surface of the second extending section 42, wherein a preferable value of the distance T4 is not shorter than 0.5 mm and not longer than 4 mm.

When ink in the ink chamber 13 decreases, the damper membrane 17 deforms such that it shrinks toward the inner side of the ink chamber 13. A certain level of negative pressure is required in order to prevent leakage of ink from the nozzles of the recording head 7. When the damper membrane 17 shrinks toward the inner side, the coil spring 18 acts to push the damper membrane 17 back to the initial position by its reaction force, thereby generating a negative pressure inside the ink chamber 13 of the damper 12 and in the ink supply tube 9a from the damper 12 to the recording head 17. On the other hand, in order to jet ink properly from the nozzles, it is required that a certain pressure is applied to the nozzles of the recording head 7 by the gravity of ink in the damper 12 and in the ink supply tube 9a between the damper 12 and the recording head 7. When ink is stored in the damper 12 in more than a certain amount, a proper pressure can be secured to be applied to the nozzles, and thus ink can be jetted smoothly by a jetting force of the recording head 7. However, when a negative pressure generated in the ink supply tube 9a from the damper 12 to the recording head 7 becomes larger than a certain limit, ink cannot be jetted properly only by the ink jetting force of the recording head 7. Therefore, in order to maintain a proper pressure to be applied to the nozzles, the surface position of the damper membrane 17 can be detected by the membrane surface detection section 19. Thus, it is possible to properly determine whether the amount of ink in the damper 12 is maintained constant.

At the midway of the ink supply tube 9a and between the damper 12 and the sub-tank 10, a liquid feed pump 23 is provided to feed ink into the damper 12. When it is determined that the amount of ink in the damper 12 is smaller or equal to the predetermined amount, the liquid feed pump 23 forcibly feed the ink stored in the sub-tank 10. Various pumps, such as a diaphragm pump and a gear type pump, can be applied to the liquid feed pump 23.

A supply valve 24 is provided at the midway of the ink supply tube 9b to restrict inflow of ink from the main tank 11 into the sub-tank 10. The supply valve 24 is, for example, a solenoid valve having a solenoid and a diaphragm (neither is shown), wherein the solenoid opens and closes for liquid flowing into and out of the diaphragm, thus the valve opening and closing. Herein, the mechanism for restricting inflow and outflow of ink is not limited to this, and various valves having another structure and other various mechanisms are also applicable.

Further, a recording medium P used in the present embodiment can be various materials including various papers, such as a plain paper, recycled paper, and gloss paper, various cloths, various non-woven cloths, resins, metals, glasses, which are non-ink-absorbent, and others. The form of the recording medium P can be a roll form, cut-sheet form, plate form, and other various forms.

Next, the control structure of the inkjet printer 1 in the present embodiment will be described, referring to FIG. 4.

The inkjet printer 1 includes a control section 25 for controlling each part of the inkjet printer 1, and a power supply 26 is connected to the control section 25 to supply power to the inkjet printer 1.

Also, to the control section 25 and as an electric signal, transmitted is the detection result of detecting as to what extent the membrane surface of the damper membrane 17 is deformed inside the ink chamber 13 from the membrane surface detection section 19. The control section 25 determines whether more than or equal to the predetermined amount of ink is remaining in the ink chamber 13, according to this detection result. If it is determined that the amount of ink in the ink chamber 13 is less than the predetermined amount, the control section 25 operates the liquid feed pump 23 to supply ink from the sub-tank 10 into the damper 12. The membrane surface of the damper membrane 17 is detected by the membrane surface detection section 19, when performing image recording with the carriage 6 moving at a constant speed. When performing image recording while the carriage 6 is reciprocally moving on the platen 2, the carriage 6 moves at a constant moving speed to perform stable image recording. However, excluding when image recording, the moving speed of the carriage 6 is accelerated because control with high accuracy is not necessary, or decelerated in order to change the moving direction of the carriage 6, and thus the moving speed of the carriage 6 is not constant. Further, in performing cleaning operation of the recording head 7, ink is forcibly sucked and idle ink-jetting is performed, which causes sudden variation in the ink amount in the ink chamber 13. Accordingly, even if the membrane surface of the damper membrane 17 is detected other than when performing image recording with the carriage 6 moving at a constant speed, it is unexpected to obtain an accurate value. Detection of the membrane surface may be performed only when performing image recording. It also may be that the membrane surface is always detected or at a predetermined interval, and it is determined whether ink is remaining in the ink chamber 13 or not, only according to detection results obtained during image recording.

When the control section 25 determines that the amount of ink in the ink chamber 13 of the damper 12 is less than the predetermined amount, according to a signal transmitted from the membrane surface detection section 19, the control section 25 properly operates the liquid feed pump 23 to feed ink in a proper amount that can be stored in the ink chamber 13 from the sub-tank 10 to the ink chamber 13 of the damper 12 so that the amount of ink stored in the ink chamber 13 of the damper 12 is maintained to be constant.

Further, the detection result of the ink amount in each sub-tank 10 is transmitted from the sub-tank sensor 27 to the control section 25. When the control section 25 determines, from this detection result, that the ink amount in the sub-tank 10 is less than or equal to the predetermined amount, the control section 25 operates a supply valve 24 to open the supply valve 24 for a predetermined time so that ink in each main tank 11 is supplied to the respective sub-tank 10. Herein, the time period for opening the supply valve 24 is set in advance to be, for example, 10 seconds, 20 seconds, or the like, to open the supply valve 24 for the set time period. The time period for opening the supply valve 24 may be set respectively depending on the kind of ink or the like.

According to information on the membrane surface position of the damper membrane 17 transmitted from the membrane surface detection section 19, when it is determined that the position of the membrane surface of the damper membrane 17 is not changed even operating the liquid feed pump 23, the control section 25 determines that there is no remaining ink in the main tank 11. Herein, the time period from starting the operation of the liquid supply pump 23, according to which the control section 25 determines that no ink is remaining in the main tank 11, may be changed, corresponding to various conditions, such as the type of ink, ambient temperature, etc. This is because, for example, if the ink has a high viscosity or the ambient temperature is low, the flow speed of the ink is slower than in a case where the viscosity of the ink is low, and thus it takes the ink a longer time to reach the ink chamber 13 of the damper 12 even operating the liquid feed pump 23. In such a way, the time it takes for ink to reach the ink chamber 13 of the damper 12 from when the liquid feed pump 23 is started is effected by the viscosity of the ink or others.

Further, the control section 25 controls the carriage driving mechanism 29 to reciprocally moves the carriage 6 in the main scanning direction, and controls the recording medium conveying mechanism 30 to operate the conveying rollers 3 and 4, thus repeating conveying and stopping the recording medium P in synchronization with the operation of the carriage 6 and intermittently conveying the recording medium P in the conveying direction X.

Still further, the control section 25 operates the recording head 7 to heat ink in the ink flow path of the recording head 7 to a range approximately from 30° C. to 150° C. and forms an image by jetting ink onto the recording medium P as tiny liquid droplets in a size of 2 to 20 pl per dot. Yet further, the control section 25 controls a UV light emitter 8 to emit UV light from a UV light source onto ink having reached the recording medium P.

Next, operation and effects in the present embodiment will be described.

When a power supply source 26 of the inkjet printer 1 is turned on, the power supply source 26 supplies electricity to each part of the inkjet printer 1, and the carriage 6 having the recorded head 7 mounted thereon moves above the platen 2.

When the carriage 6 reaches a predetermined position, the conveying rollers 3 and 4 convey the recording medium P in the conveying direction X for a predetermined distance, and then the carriage 6 reciprocally moves along the main scanning direction. Herein, a predetermined voltage is applied to the piezo device of the recording head 7 to compress the ink flow path, and a thus generated jetting force attracts ink in the ink chamber 13 of the damper 12 into the ink flow path of the recording head 7, thus ink in a required color is jetted from nozzles, based on certain image information. Further, the UV light emitter 8 irradiates UV light onto the jetted ink, thereby recording a certain image on the recording medium P.

When ink is jetted from the recording head 7, ink stored in the ink chamber 13 of the damper 12 is sequentially supplied to the recording head 7, which decreases ink in the ink chamber 13. When the ink in the ink chamber 13 decreases, and accordingly, the damper membrane 17 deforms shrinking toward the inner side of the ink chamber 13. When the damper membrane 17 shrinks toward the inner side, the coil spring 18, by its reaction force, tends to push the damper membrane 17 back to the initial position, by which a negative pressure is generated in the ink chamber 13 of the damper 12 and in the ink supply tube 9a from the damper 12 to the recording head 7. The membrane surface position of the damper membrane 17 is properly detected by the membrane surface detection section 19, and the detection result is transmitted to the control section 25.

When it is detected that the damper membrane 17 has moved inner than the regulated position by the regulating member 40 for a predetermined distance, ink in an amount that can be stored in the ink chamber 13 is fed by the liquid feed pump 23 from the sub-tank 10. When ink is properly fed, the pressure of the ink having flowed in the ink chamber 13 presses the damper membrane 17 such that the membrane 17 expands outward, and accordingly, the damper membrane 17 presses the rod 20 of the membrane surface detection section 19 into inside the body of the membrane surface detection section 19. Thus, a change in the position of the damper membrane 17 is recognized. Herein, if the predetermined distance is set not shorter than 0.5 mm and not longer than 4 mm as mentioned above, the pressure in the ink chamber 13 can be maintained in a range −3 cm H₂O to −13 cm H₂O. If this pressure condition is maintained, ink can be stably supplied to the recording head 7.

The amount of remaining ink in the sub-tank 10 is detected by the sub-tank sensor 27. When the amount of ink in the sub-tank 10 is smaller than the predetermined amount, the supply valve 24 is properly opened and ink in a required amount is supplied from the main tank 11 to the sub-tank 10 through the ink supply tube 9b.

As stated above, according to the present embodiment, the regulating member 40 is disposed outside the damper membrane 17 and inner than the maximum expansion position of the damper membrane 17 to regulate the expanding amount of the damper membrane 17. Therefore, even when the maximum expanding amount (amount of displacement) of the damper membrane 17 has variation, the expanding amount can be made uniform due to regulation by the regulating member 40. If the expanding amount of the damper membrane 17 is uniform, motion of the rod 20 can also be made uniform even without adjusting the setting position of the membrane surface detection section 19, making it possible to detect the amount of ink always with reference to a predetermined amount.

In this way, even with variation in the maximum expanding amount of the damper membrane surface 17, making the detected amount of ink uniform makes it unnecessary to adjust the setting position of the membrane surface detection section 19, and consequently, it is always possible to perform constant ink amount detection. In such a manner, the stability of ink jetting is secured.

The elastic member holds the damper membrane 17 at the initial position. Therefore, when ink in the ink chamber 13 decreases, the elastic member pushes back the damper membrane 17, which tends to shrink toward the inner side of the ink chamber 13, thereby maintaining a constant negative pressure in the damper 12. Thus, no matter whether ink flows in or flows out, it is possible to jet ink from the recording head stably, and also possible to prevent ink from leaking from the recording head other than during image recording.

In the present embodiment, the sub-tank 10 is provided in addition to the damper 12, and ink in the main tank 11 is temporarily supplied to the sub-tank 10, and then supplied to the damper 12. However, ink in the main tank 11 may be directly supplied to the damper 12 without providing the sub-tank 10 as shown in FIG. 4. In this case, the supply vale 24 between the main tank 11 and the sub-tank 10 is also unnecessary, allowing a simple device structure. The sub-tank 10, in general, maintains a constant negative pressure in the recording head 7 and in the ink supply tube 9a to prevent leakage of ink from the recording head 7 other than during image recording. In the present embodiment, a negative pressure in the recording head 7 and the ink supply tube 9a is maintained by the damper membrane 17 of the damper 12 and the coil spring 18. Accordingly, leakage of ink from the recording head 7 is prevented even without providing the sub-tank 10.

The recording head 7 applied to the inkjet printer 1 in the present embodiment can be either an on-demand type or a continuous type. In terms of a jetting method, a recording head 7 of any of the following types can be applied, which are, for example, an electromechanical conversion method (such as a single cavity type, double cavity type, vendor type, piston type, shared mode type, shared wall type), electro-thermal conversion method (such as a thermal inkjet type, bubble jet (a registered trademark) type), electrostatic suction method (such as an electric field control type, slit jet type), discharging method (such as spark jet type), and the like.

Further, in the present embodiment, image recording is performed using ink that is curable by irradiating UV light. However, the ink used in the present embodiment is not limited to this, and may be ink curable by irradiating light other than UV light, such as electron ray, electromagnetic wave including X ray, visual light, and infrared ray. In such a case, polymerization compounds polymerizable and curable by light other than UV light, and a photo-initiator for initiation of polymerization reaction between polimerizable compounds by light other than UV light, are applied as the ink. When using photo-curable ink curable by light other than UV light, a light source emitting such light is applied instead of a UV light source. It is also possible to use ink that can be cured and fixed without irradiating light. In this case, it is not necessary to provide a UV-light emitter.

Further, the inkjet printer 1 in the present embodiment is a serial type inkjet printer, which reciprocally moves the recording heads 7 mounted on the carriage 6 along the main scanning direction, and jets ink from the recording heads 7 to form an image, while conveying a recording medium P in the conveying direction X. However, an inkjet printer 1 in accordance with the invention may be a line-head type inkjet printer which jets ink from recording heads fixed to the main body of the printer while conveying a recording medium, and thus forms an image.

While the preferred embodiments of the present invention have been described using specific terms, such description is for illustrative purposes only, and it is to be understood that changes and variations may be made without departing from the spirit or scope of the appended claims.

What is claimed is:

1. An inkjet printer, comprising:
an ink-tank for storing ink;
a recording head for jetting ink onto a recording medium;
an ink-supply tube for supplying ink from the ink-tank to the recording head;
a damper for temporarily storing ink at a midway of the ink-supply tube;
an ink-feed pump for feeding ink to the damper, the pump disposed between the ink-tank and the damper;
an ink detection section for detecting whether an ink amount in the damper is greater than or equal to a predetermined amount; and
a control section for performing control to stop the ink-feed pump if a detection result by the ink detection section is greater than or equal to the predetermined amount, and drive the ink-feed pump if the detection result is smaller than the predetermined amount,
wherein the damper includes an ink chamber for storing ink supplied from the ink supply tube;
a damper membrane that covers at least one surface of the ink chamber and expands and shrinks, corresponding to an ink amount in the ink chamber; and
a regulating member for regulating an expansion amount of the damper membrane to regulate an ink amount in the ink chamber, the member disposed outside the damper membrane and on an inner side than a maximum expansion position of the damper membrane, and
wherein the ink detection section includes a moving section that moves according to a displacement of the damper membrane while having contact with an outer surface of the damper membrane; and
a detection sensor for detecting whether the ink amount in the damper is greater than or equal to the predetermined amount, based on a travel distance of the moving section.

2. The inkjet printer of claim 1, wherein the detection sensor determines that the ink amount in the damper is less than the predetermined amount if the moving section is inside a regulated position by the regulating member of the damper for a predetermined distance, and the predetermined distance is longer than or equal to 0.5 mm and shorter than or equal to 4 mm.

3. The inkjet printer of claim 1, wherein the damper includes an elastic member that is in contact with the damper membrane from inside the ink chamber and supports the damper membrane at an initial position.

4. The inkjet printer of claim 1, wherein the recording head heats ink, the ink being a liquid with a viscosity in a range from 10 to 500 mPa·s at 30° C., up to a range from 30° C. to 150° C. by a heater so as to jet the ink with a droplet size in a range from 2 to 20 pl per dot.

5. The inkjet printer of claim 1, comprising a light emitter for irradiating light onto ink having reached the recording medium, wherein the ink is a photo-curable ink curable by irradiating light and the light emitter is disposed on a downstream side of the recording head in a direction the recording medium is conveyed.

6. The inkjet printer of claim 5, wherein the ink is a UV-curable ink curable by irradiating UV light, and at least a part of light emitted by the light emitter is UV light.

7. The inkjet printer of claim 1, wherein the ink is an ink that has a high viscosity and is a cation polymerization UV curable ink.
